(19) United States
(12) Patent Application Publication
(10) Pub. No.: US 2002/0068610 A1
(43) Pub. Date: Jun. 6, 2002

(54) Method and apparatus for selecting source device and content delivery via wireless connection

(76) Inventors: Dinesh Kashinath Anvekar, Piscataway, NJ (US); Bhaskarpillai Gopinath, Watchung, NJ (US)

Correspondence Address: Guy H. Eriksen,, Lotus Management, L.L.C.,, Suite N320,, 255 Old New Brunswick Road,, Piscataway, NJ, 08854, US

(21) Appl. No.: 09/730,135

(22) Filed: Dec. 5, 2000

(51) Int. Cl. H04M 1/00; H04B 1/38

(52) U.S. Cl. 455/560; 455/568; 455/550; 455/557

(57) ABSTRACT

Personal communication, entertainment, and data needs are robustly enhanced utilizing a headset or other interactive device comprising a user interface apparatus, a wireless transceiver, and a switching module; wherein the wireless transceiver is used for transport of content between the user interface device and a plurality of source devices, and the switching module is coupled to and interposed between the user interface apparatus and the wireless transceiver and is used to select specified source devices for wireless coupling with the user interface.

### FIELD OF THE INVENTION

The present invention relates to the field of personal communication, data, and entertainment devices.

### BACKGROUND OF THE INVENTION

Hands-free earphones, earpieces, headphones, and other audio transducers (collectively referred to herein as audio headsets for the sake of simplicity) are commonly used in conjunction with cellular phones and other audio devices such as music players (cassette, CD, MP3, etc.), radios, wired telephones, personal computers, and the like. One beneficial aspect gained through the use of hands-free audio headsets is the unencumbered use of a speaker, earphone, or other audio delivery transducer without requiring the user to constantly hold the device to perceive the audio content. Another beneficial aspect is that delivery of the audio content is consistently delivered to the user, regardless of user location or position, while the headset is affixed to the head of the user. Yet another beneficial aspect is that audio content delivery is personal to the user himself and non-obtrusive to those nearby since the headset holds the audio transducer(s) next to the user's ear(s), thus requiring audio content volume only loud enough for perception by the user.

Despite the enormous benefit derived by the use of hands-free audio headsets, there are also some detrimental or negative aspects associated with use of such devices. One detrimental aspect is that dangling wires or cables used for delivery of audio content from an audio device to the audio headset are often cumbersome and inconvenient. Also, in an example in which the user has a plurality of audio devices (such as a cellular phone, one or more music players, etc.), frequently the various device headsets are incompatible with one another and the user must change headsets to change the audio device he is listening to. In the instance in which two or more audio devices may utilize a common device headset and the user wants to stop listening to a first device and begin listening to a second device, the user must first disconnect the headset from the first device and then reconnect the headset to the second device.

In an effort to overcome some of these deficiencies, a wireless connection or link between audio source devices and an audio headset may be used. For example, LM Ericsson Telephone Co. has developed a Bluetooth™ standard cellular phone headset. The Bluetooth™ standard is a radio technology standard developed by a consortium of companies in which a chip is used within a device in order to transmit signals over short distances between telephones, computers and other devices without the use of wires. The Ericsson headset is a wireless mobile phone headset, with a built-in Bluetooth™ radio chip that acts as a connector between the headset and a Bluetooth™ plug on a cellular phone. While this eliminates the detrimental aspects associated with dangling wires and cables and allows for greater freedom and range of motion, such technology may only be used with those phones or other devices having built in Bluetooth™ compatible radio connection chips.

### SUMMARY OF THE INVENTION

These and other limitations associated with the prior art are overcome by the present invention in which a personal headset device is comprised of a user interface apparatus, a wireless transceiver, and a switching module, wherein the wireless transceiver is used for transport of content between the user interface device and a plurality of source devices, and the switching module is coupled to and interposed between the user interface apparatus and the wireless transceiver and is used to select specified source devices for wireless coupling with the user interface.

### BRIEF DESCRIPTION OF THE DRAWINGS

A more complete understanding of the present invention may be obtained from consideration of the following description in conjunction with the drawings in which:

FIG. 1 is a block diagram of an exemplary embodiment of a wireless headset system, in accordance with the principles embodied in the present invention;

FIG. 2 is a block diagram of an exemplary embodiment of a wireless audio headset device, in accordance with the principles embodied in the present invention;

FIG. 3 is a block diagram of an exemplary embodiment of an audio source device, in accordance with the principles embodied in the present invention;

FIG. 4 is a block diagram of an exemplary embodiment of the present invention in which two audio source devices are utilized as the source devices, in accordance with the principles embodied in the present invention;

FIG. 5 is a representation of an exemplary method employed in selecting between competing audio source devices, in accordance with the principles embodied in the present invention; and

FIG. 6 is a representation of an embodiment of the present invention in which a plurality of audio source devices' content are multiplexed.

### DETAILED DESCRIPTION

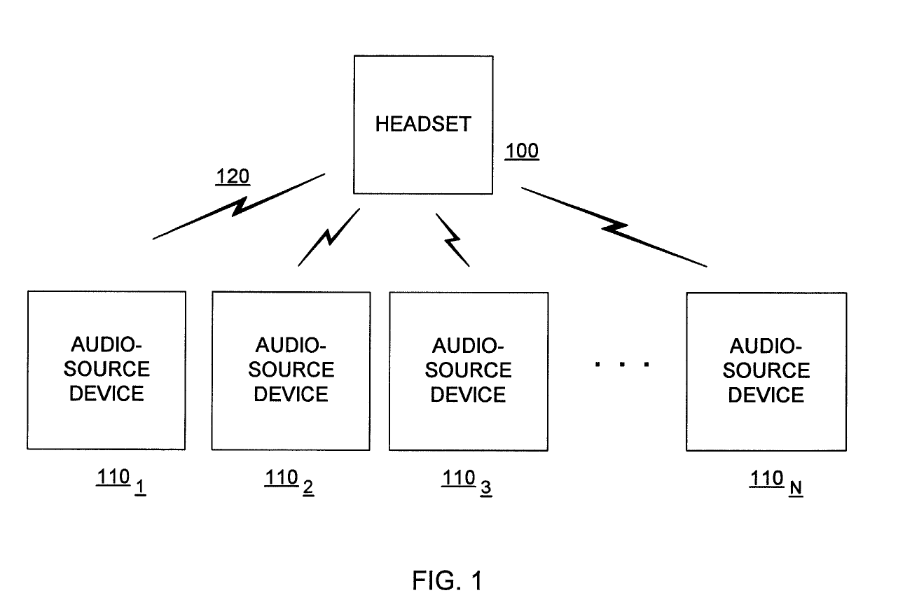

FIG. 1 is a block diagram of an exemplary embodiment of a wireless headset system, in accordance with the principles embodied in the present invention. The headset 100 is linked to various source devices, in the instant embodiment a plurality of audio source devices 110₁-110_{N}, via a wireless medium 120. An audio headset is illustrated in the instant embodiment, which may include any well-known audio user interface used as a transducer, including but not limited to earphones, earpieces, headphones, speakers, microphones, etc. The headset need not be comprised of an audio user interface, but may include one or more of any manner of user interface apparatus, including but not limited to the aforementioned audio user interfaces, video user interfaces such as video display modules, touch-pad interfaces, biometric sensors and devices, voice recognition modules, and the like. Furthermore, although illustrated and described as incorporated within a headset 100, the present invention need not be manifested in a headset at all; rather, the invention may be incorporated within any device wearable, attachable, or otherwise borne by a human.

Similarly, although illustrated in the instant embodiment as audio source devices, source devices are not to be construed as constrained merely to audio devices, and may include, by way of example and not limitation, audio and voice devices such as cellular and other wireless phones and communication devices, wired phones, music players such as cassette players, compact disc players, MP3 players, radios, personal computers, personal digital assistants and other information appliances. In one embodiment of the present invention in which the user interface is an audio interface, the headset 100 may selectively choose one or more audio-source devices to produce audio input to either ear or both ears of the user. As would be apparent to those skilled in the art, the wireless medium 120 link between the headset 100 and the applicable source device(s) may be accomplished utilizing digital wireless link standards such as Bluetooth™ or IEEE 802.11.

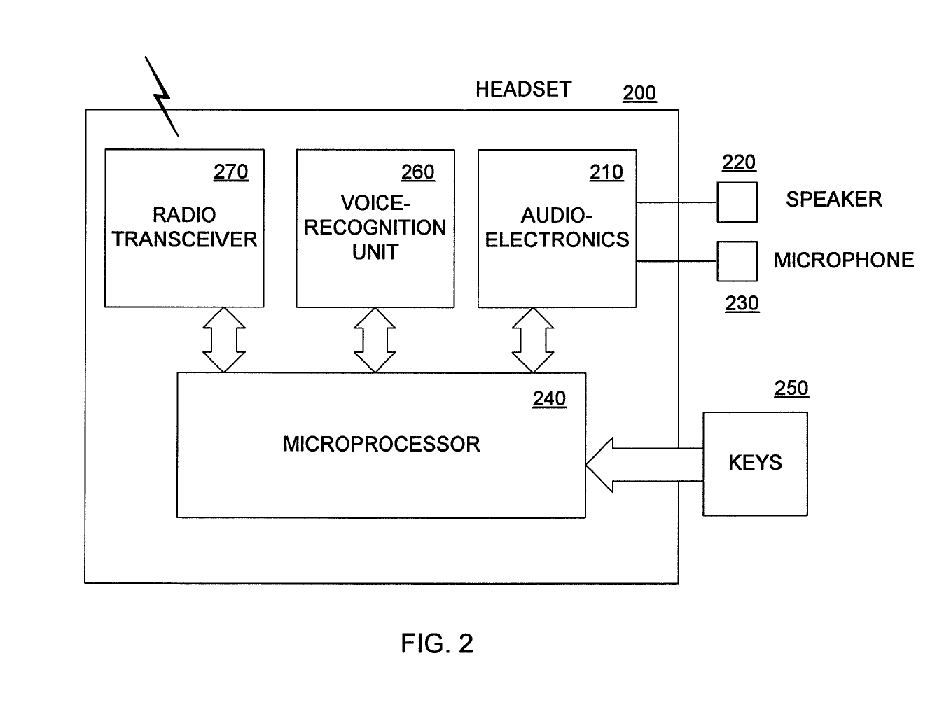

FIG. 2 is a block diagram of an exemplary embodiment of a wireless audio headset device 200, in accordance with the principles embodied in the present invention. The audio-electronics subsection 210 is comprised of standard electronics and audio signal processing circuitry to produce an audio output at the speaker 220. The electronics circuitry is comprised of one or more of the following arrangements to produce a desired intensity and frequency band of audio signal at the speaker 220, including but not limited to audio amplifiers, impedance matching circuits, attenuators, tuners, filters and the like. The audio-electronics subsection 210 is also comprised of circuitry to process the signals that come from the output of the microphone 230, and to produce digital electronic signals for use by the microprocessor 240. The various functional capabilities of the audio-electronics section 210 are controlled by the microprocessor 240. One or more keys 250 (or other interface control devices) are provided on the headset to control various control functions such as ‘on/off’, volume ‘increase/decrease’, and connection controls to specific source devices.

In the instant embodiment, the headset also includes a voice-recognition unit 00045 260 that recognizes words such as ‘cell-phone’, ‘music’, ‘radio’, ‘on’, ‘off’, etc. spoken by a human as a control command. The digital electronic signals corresponding to such sounds are received by the microprocessor 240 through the audio-electronics subsection 210, and sent to the voice-recognition unit 260. The voice recognition unit 260 sends a signal to the microprocessor 240 indicating whether the spoken voice command is a valid command and if valid, what control function to perform. The microprocessor then performs the necessary action or function related to the signal which corresponds to the spoken voice command. The microprocessor also controls the radio transceiver 270 that transmits and receives wireless command signals and content to and from the various devices (whether audio, text, data, video, or other format).

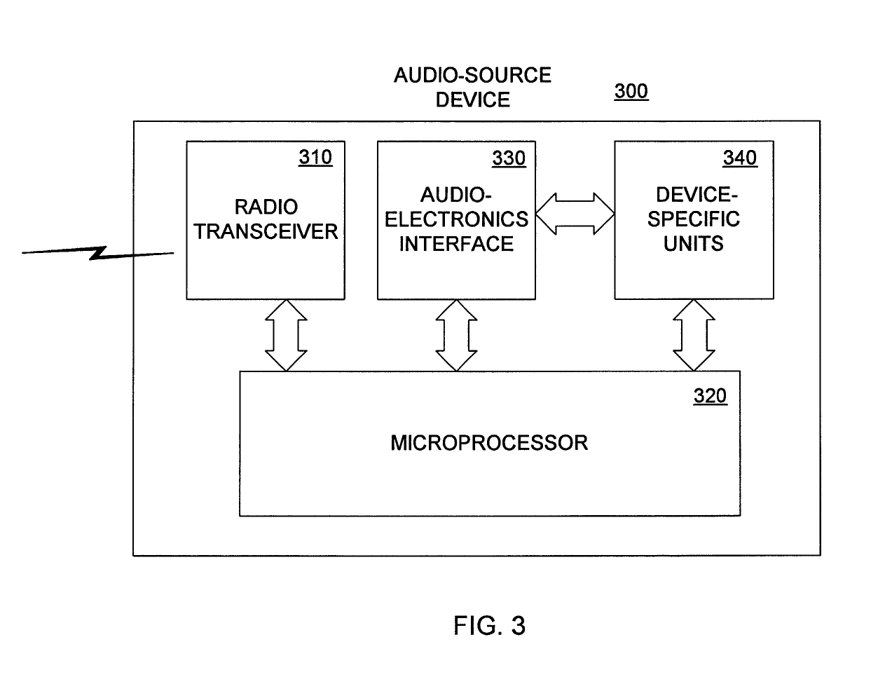

FIG. 3 is a block diagram of an exemplary embodiment of an audio source device 300, in accordance with the principles embodied in the present invention. Each audio-source device includes a radio transceiver 310 that is controlled by a microprocessor 320. The audio-electronics interface 330 provides the microprocessor with digital signals corresponding to the audio signals of the audio-source device 300. For instance, in a music player the signals will correspond to the music being played and in a cellular phone the signals will correspond to the voice input. The microprocessor transmits the digital audio signals to the wireless headset 200 via the radio transceiver 310. Similarly, radio-encoded signals corresponding to instruction codes and audio-signals, if any, from the headset 200 are received by the microprocessor via the radio transceiver 310. Device specific units 340 represent all the device/feature specific circuits and functions particular to a source device (in the instant embodiment, audio-source device 300). For example, if the audio-source device 300 is a music playing device, then device specific units 340 will include all the mechanical and electronics sections of the device.

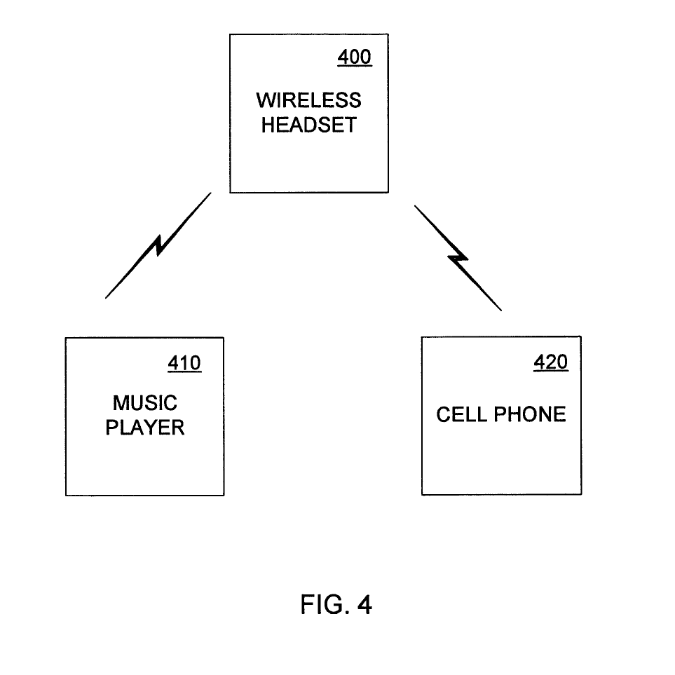

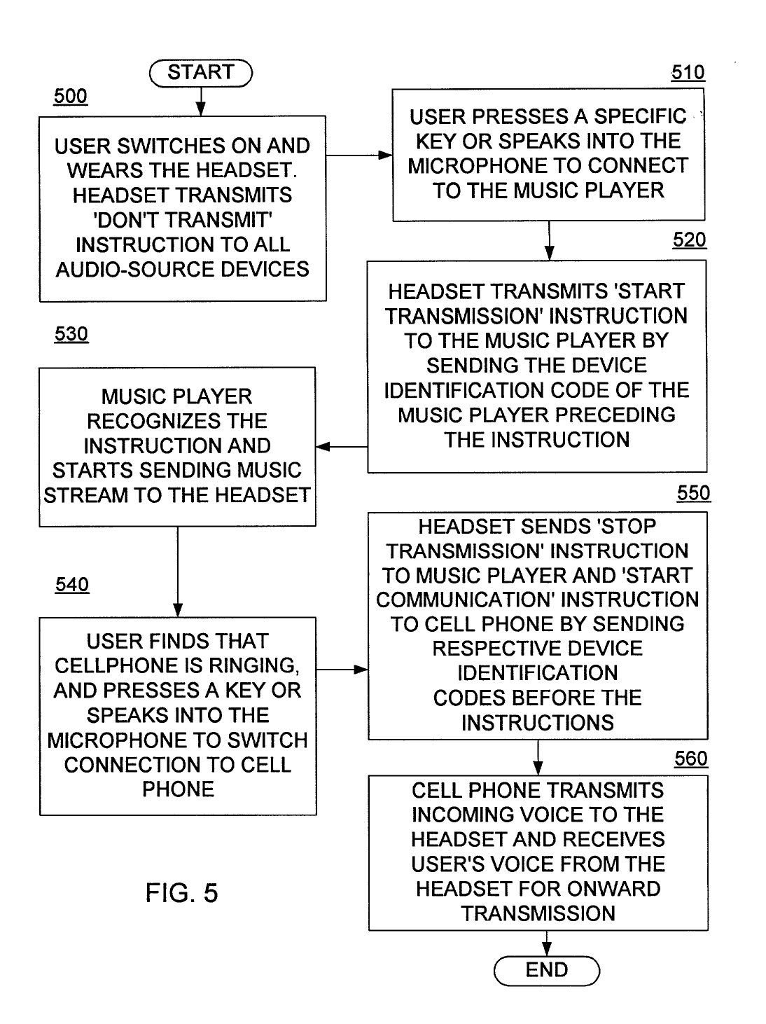

The operation of an exemplary embodiment of the present invention is illustrated and described in conjunction with FIGS. 4 and 5. FIG. 4 is a block diagram of an exemplary embodiment of the present invention in which two audio source devices are utilized as the source devices. For illustrative purposes, only two audio-source devices, a music player 410 and a cell phone 420, are shown in FIG. 4, although it would be understood to those skilled in the art that a plurality of other devices may also be included. In one embodiment of the present invention, each audio-source device is assigned a unique device identification code. To register a device with the headset 200, its device identification code is entered using the keys 250 or by sequentially uttering the code digits into the microphone. As is well-understood in the art, the number of digits chosen is sufficiently long to avoid the possible replication of code digits with devices of other headset users nearby or adjacent to the headset user.

FIG. 5 is a representation of an exemplary method employed in selecting between a plurality of personal audio source devices, in accordance with the principles embodied in the present invention. Microprocessor 240, in addition to the previously described functions, also functions as a switching module for connecting one or more user interface devices with one or more source devices. In the embodiment shown in FIG. 5, audio output from headset 400 is first initialized from a music player 410 and subsequently switched to a cell phone 420. In accordance with step 500, when initially powered on, the headset 400 transmits a ‘Don't Transmit’ message to both the music player 410 and the cell phone 420. In accordance with step 510, the user chooses to initially connect to the music player. One method of choosing a device is to press a specific key or touchpad located on the headset. Alternatively, the user may speak into the microphone using specific words directing the headphone to connect to the music player. In yet another alternative embodiment, processor 240 may be programmed to select a specific device as the power-up default source device with which the headset is to establish a link. In accordance with step 520, the headset transmits the device identification code of the music player followed by a ‘Start Transmission’ instruction. In accordance with step 530, the music player recognizes by the device identification code that it has been addressed, and starts transmitting the music signals in wireless encoded formats that are well known to those skilled in the art. Headset 400 receives the signals and plays the music on the headset speaker(s) 220. In accordance with step 540, the user next receives an incoming cell phone 420 call; and instructs the headset 400 to switch over to the cell phone by either pressing a key or uttering an instruction into the microphone 230. In accordance with step 550 and responsive to the prior step, the headset 400 sends a ‘Stop Transmission’ message to the music player 410, and sends a ‘Start Communication’ message to the cell phone. In each case, the respective device identification code is utilized to address the respective device. In accordance with step 560, the communication link between the headset 400 and cell phone 420 is established.

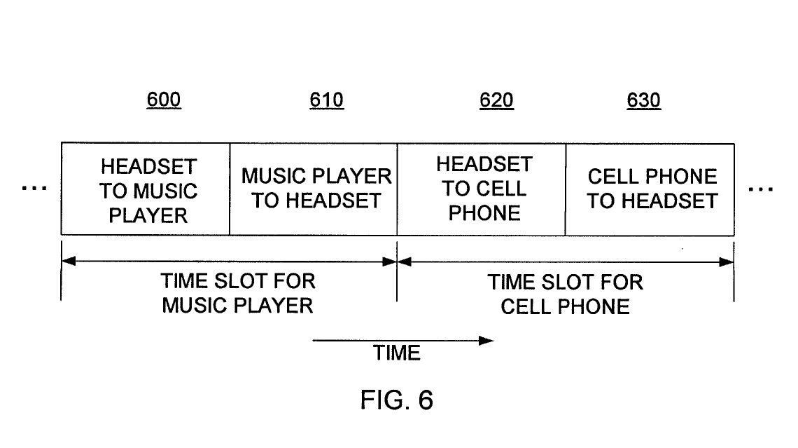

FIG. 6 is a representation of an embodiment of the present invention in which a plurality of audio source devices' content are multiplexed. In the instant time division multiplexing embodiment, each audio-source device receives from the headset and transmits to the headset in a designated time slot as shown illustratively in FIG. 6. For the purpose of illustration and not limitation, only two consecutive time slots are shown in the figure; however, it is known that time division multiplexing is performed in a repetitive modulo manner. Furthermore, in practice, the number of source devices utilized for multiplexing source content is not limited to merely two devices, but may include a plurality of source devices. Within each time slot allocated to an audio-source device, a first part (e.g., 600,620) is used for transmission from the headset to the device and a second part (e.g., 610,630) is used for transmission from the audio-source device to the headset. Thus, bidirectional communication between the headset and any included audio-source device is enabled. Within this scheme, the headset may receive the audio signal streams from several audio-source devices at the same time and selectively play through speaker(s) 220, or alternatively the two or more audio signal streams may be mixed for simultaneous reproduction over speaker(s) 220.

Although the preceding description assumes the use of a single output device or user interface (e.g.—earphones), the principles of present invention also encompass embodiments in which a plurality of user interface devices are utilized. For example, in an embodiment in which an audio recorder is used, the headset is continuously linked to an audio-recorder through wireless connectivity. When the user desires to record a conversation, the headset sends the audio stream to the audio-recorder in addition to playing it on the speaker(s). The audio-recording device can also be a stand-alone device such as a PC.

Also, while only audio-sources are assumed in the above description, it may be noted that this invention is not limited in scope only to audio-streams. In general, what is communicated over the wireless medium can be data, diagrams, still or motion pictures. In this case, the headset would act as an intelligent routing or switching device. For example, a user may download a file from a PC to a palmtop device through the headset router. First, the headset is linked to the PC and the palmtop. The user then establishes a data connection link between the palmtop and the PC. Then, a download command issued through the palmtop downloads the file into the palmtop. Further, with the advent of wearable display devices, it is possible for the routing headset device to switch the image part of an input stream to the wearable display device, and the audio part to the speaker(s). Thus, the user can use the headset to route multiple input sources to multiple output devices in general. Also, in this role, the routing device need not necessarily be worn on the head, but just carried by the user as a portable device. Furthermore, the device may include the capability to be programmed for specific action based on certain rules stored in a rules-basis engine, whether preprogrammed or programmed by the user. For example, the device may be programmed to automatically play a recorded message when the user is already busy with another call, or it could be made to automatically connect to an incoming call when the user is listening to music.

The previous description merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGS. , including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

What is claimed is:

1. A wearable device comprising:
a user interface apparatus;
a wireless transceiver for transport of content between said user interface device and a plurality of source devices;
a switching module, coupled to and interposed between said user interface apparatus and said wireless transceiver, for selecting specified ones from said plurality of source devices for wireless coupling with said user interface.

2. The device of claim 1 wherein said user interface apparatus is an audio transducer.

3. The device of claim 2 wherein said audio transducer is a speaker.

4. The device of claim 2 wherein said audio transducer is an earpiece.

5. The device of claim 2 wherein said audio transducer is at least one earphone.

6. The device of claim 2 wherein said audio transducer is a microphone.

7. The device of claim 1 wherein said user interface apparatus is a video display.

8. The device of claim 1 wherein said user interface apparatus is a voice recognition module.

9. The device of claim 1 wherein said user interface apparatus is a touch-pad surface.

10. The device of claim 1 wherein said user interface apparatus is a biometric device.

11. The device of claim 1 wherein at least one of said plurality of source devices is a cellular phone.

12. The device of claim 1 wherein at least one of said plurality of source devices is a personal computer.

13. The device of claim 1 wherein at least one of said plurality of source devices is a personal digital assistant.

14. The device of claim 1 wherein at least one of said plurality of source devices is an audio device.

15. The device of claim 14 wherein said audio device is a cassette player.

16. The device of claim 14 wherein said audio device is a radio.

17. The device of claim 14 wherein said audio device is a compact disc player.

18. The device of claim 1 further comprising:
a plurality of user interface apparatuses,
wherein selection of connectivity between ones of said plurality of user interface apparatuses and ones of said plurality of source devices is accomplished using said switching module.

19. The device of claim 18 wherein said selection of connectivity is accomplished utilizing a hierarchical rules-basis engine driving said switching module.

20. An apparatus for delivering multiple audio outputs to a common transducer comprising:
a transceiver adapted to receive a plurality of wireless signal transmissions from a respective plurality of signal producing equipment;
a microprocessor for selecting at least one of said plurality of wireless signal transmissions from said plurality of signal producing equipment;
an audio signal processor for converting said at least one of said plurality of wireless signal transmissions into at least one audio output signal; and
a transducer for converting said at least one audio output signal into an audible output soundwave.
